(19) United States
(12) Patent Application Publication
(10) Pub. No.: US 2011/0142718 A1
(43) Pub. Date: Jun. 16, 2011

(54) GLUCOSE SENSOR CHIP

(75) Inventors: Masaaki HIRAKAWA, Kanagawa-ken (JP); Ikuo Uematsu, Kanagawa-ken (JP)

(73) Assignee: KABUSHIKI KAISHA TOSHIBA, Tokyo (JP)

(21) Appl. No.: 12/966,548

(22) Filed: Dec. 13, 2010

(30) Foreign Application Priority Data
Dec. 15, 2009 (JP) 2009-284581

(51) Int. Cl. G01N 21/00

(52) U.S. Cl. 422/82.11

(57) ABSTRACT

According to one embodiment, a glucose sensor chip includes an optical waveguide layer on a main surface of a substrate, the optical waveguide layer including a pair of gratings which are separated each other, a sensing film on a surface of a portion of the optical waveguide layer between the pair of the gratings, the sensing film being constituted with a membrane polymer, a cross-linking polymer and a low-molecular compound, the sensing film including a first enzyme which oxidizes or reduces a color forming dye and a glucose, and a second enzyme which reacts with a product of the first enzyme and generates a material which produces the color forming dye.

### CROSS REFERENCE TO RELATED APPLICATION

This application is based upon and claims the benefit of priority from prior Japanese Patent Application No. 2009-284581, filed on Dec. 15, 2009, the entire contents of which are incorporated herein by reference.

### FIELD

Exemplary embodiments described herein generally relate to a glucose sensor chip.

### BACKGROUND

As shown in FIG. 7 as a conventional case, a glucose sensor chip 11 is disposed on a main surface of a substrate 12 and includes an optical waveguide layer 13 and a sensing film 15.

The substrate 12 has gratings 14 at both edge portions. A sensing film 15 is disposed on a surface of the optical waveguide layer 13 between the gratings 14 and reacts with glucose in a sample solution so that color of the sensing film 15 changes.

The sensing film 15 is fabricated by a membrane polymer (for example, cellulose derivative such as carboxymethylcellulose (CMC)) and a cross-linking polymer (for example, a copolymer such as 2-methacryloyloxyethylphosphorylcholine (MPC) or butylmethacrylate (BMA)).

The sensing film 15 includes a color forming dye (for example, 3,3′,5,5′-tetramethylbenzine (TMBZ)), a first enzyme (for example, glucoseoxidase (GOD)) which oxidizes or reduces glucose, and a second enzyme (for example, peroxidase (POD)) which generates a material reacting with a product of the first enzyme so as to produce a color forming dye.

However, a cellulose derivative membrane of a binder is hydrogen-bonded between molecules, so that the sensing film becomes high density over time so as to cause aggression in the sensing film of the conventional glucose sensor chip.

Accordingly, a problem mentioned below can be generated. Namely, permeability of the sensing film is decreased, so that the sample solution hardly penetrates into the sensing film to easily decrease sensitivity.

### BRIEF DESCRIPTION OF THE DRAWINGS

FIG. 1 is a cross-sectional view showing a glucose sensor chip in the embodiment;

FIG. 2 is a table showing combinations between a color forming dye and both a first enzyme and second enzyme in a sensing film of the embodiment;

FIG. 3 is a graph showing a change of absorbance (sensitivity) with accompanying progress of a storage period in a case of adding trehalose into the glucose sensor chip in the embodiment and a glucose sensor chip in a conventional case;

FIG. 4 is a graph showing a change of absorbance (sensitivity) with accompanying progress of a storage period in a case of adding sucrose into the glucose sensor chip in the embodiment and the glucose sensor chip in the conventional case;

FIG. 5 is a graph showing a relationship between absorbance and concentrations of trehalose or sucrose in the glucose sensor chip.

FIGS. 6A and 6B are SEM images showing the surface states of the sensing films in the glucose sensor chips according to the embodiment and the conventional case, respectively.

FIG. 7 is a cross-sectional view showing is the glucose sensor chip in the conventional case.

### DETAILED DESCRIPTION

According to one embodiment, a glucose sensor chip includes an optical waveguide layer on a main surface of a substrate, the optical waveguide layer including a pair of gratings which are separated each other, a sensing film on a surface of a portion of the optical waveguide layer between the pair of the gratings, the sensing film being constituted with a membrane polymer, a cross-linking polymer and a low-molecular compound, the sensing film including a first enzyme which oxidizes or reduces a color forming dye and a glucose, and a second enzyme which reacts with a product of the first enzyme and generates a material which produces the color forming dye.

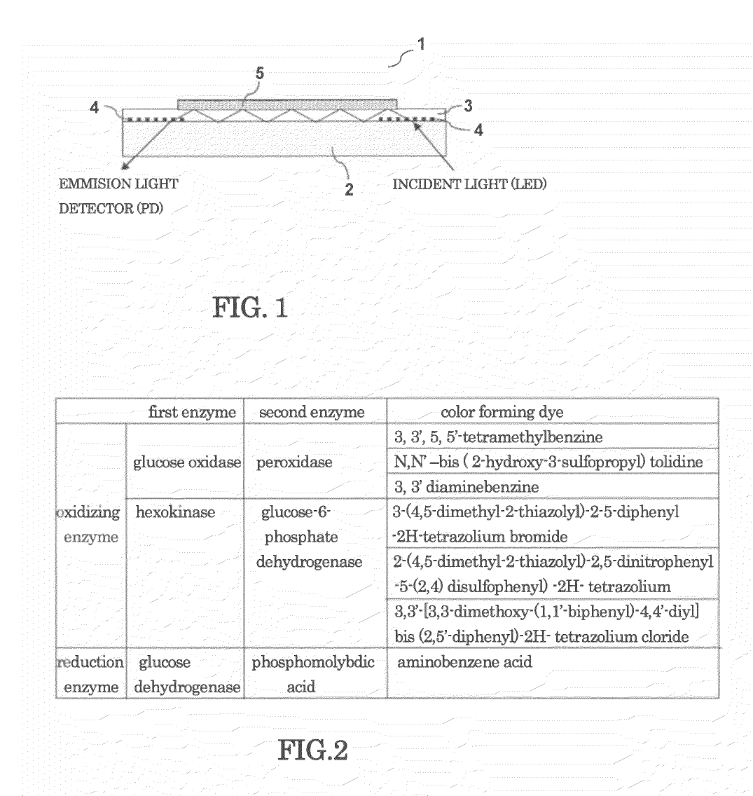

An embodiment will be described below in detail with reference to the attached drawings, FIGS. 1-6, mentioned above. Throughout the attached drawings, similar or same reference numerals show similar, equivalent or same components.

As shown in FIG. 1, a glucose sensor chip 1 is constituted with a substrate 2, an optical waveguide layer 3 and a sensing film 5.

The optical waveguide layer 3 is disposed on a main surface of the substrate 2 and a pair of gratings 4 at both edge portions in which light is incident and is emitted, respectively. Further, the substrate 2 is constituted with an optical transparency glass.

An optical waveguide layer with a planar shape, for example, is used as the optical waveguide layer 3. The planar optical waveguide layer is fabricated by, for example, silicon oxide, glass, titanium oxide or organic resin material such as phenolic resin or epoxy resin. Further, a material having transparency for prescribed light is desired as the optical waveguide layer with the planar shape. A desired material is optimally epoxy resin or the like with polystyrene as a main component.

The sensing film 5 is constituted with a transparent film and disposed on a surface of the optical waveguide layers 3 between the pair of the gratings 4. The sensing film 5 is constituted with a membrane polymer, a cross-linking polymer and a low-molecular compound. The sensing film 5 retains a color forming dye, a first enzyme which oxidizes or reduces glucose, and a second enzyme which generates a material reacting with a product of the first enzyme so as to produce a color forming dye. The color forming dye, the first enzyme and the second enzyme are retained with accompanying an active state in the sensing film 5.

As shown in FIG. 2, for example, the color forming dye in the sensing film 5 and both the first enzyme and the second enzyme are combined to be used.

As the membrane polymer, for example, cellulose can be included. An ionic cellulose derivative or a nonionic cellulose derivative can be used as cellulose, for example.

As the ionic cellulose derivative, for example, carboxymethylcellulose, cellulose sulfate, their salt compounds, anionic cellulose derivative, its salt compound, cationic cellulose derivative such as chitin, chitosan or the like, their salt compounds such as hydrochloride salt or the like can be included. These materials can be used as a form of an element substance or a composite. Here, sodium salt, potassium salt or the like is included as salt compound.

As the nonionic cellulose derivative, for example, alkylacellulose such as methylcellulose or ethylcellulose; hydroxyalkylacellulose such as hydroxyethylcellulose, hydroxypropylcellulose; hydroxyalkylalkylacellulose such as hydroxypropylmethylcellulose, hydroxypropylethylcellulose, hydroxydiethylcellulose or hydroxyethylmethylcellulose; and microfibloincellulose or the like. These materials can be used as an element substance or a composite.

As the cross-linking polymer, for example, copolymer with hydrophilic monomer and hydrophobic monomer which have at least one selected from hydroxyl group, carboxyl group, amino group and ionic functional group can be selected. Experimental results confirm that a copolymer with 2-methacryloyloxyethylphosphorylcholine and butylmethacrylate is desired as the copolymer with the hydrophilic monomer and the hydrophobic monomer.

Further, the cross-linking polymer is desired to be included 10⁴-10 weight % in weight ratio with respect to all components of the sensing film 5. When a content of the cross-linking polymer was less than 10⁴ weight % to whole components, it is difficult to prevent the sensing film from dissolving to be disintegrated or the color forming dye, the enzyme or the like retained in void of the sensing film from dissolving to an sample solution in warming. On the other hand, when the content of the cross-linking polymer is more than 10 weight % to whole components, the amount of the color forming dye or the enzyme in the film may be relatively decreased to decrease sensitivity.

The low-molecular compound is nearly 1.8% in the whole material which is constituted with the film. Accordingly, for example, disaccharide such as trehalose, sucrose, maltose or the like can be used as the low-molecule compound. Especially, the experiments confirm that it is desired to utilize trehalose.

Further, the concentration of the disaccharide in an adding process is desired to be more than nearly 2 μM. The reason is described as follows. When the concentration is lower than 2 μM, the concentration is not enough less amount to prevent aggregation of cellulose derivative in the film, so that the sensing film 5 is difficult to react with the sample solution. On the other hand, when the concentration is increased up too high, for example, over 200 μM, the film becomes opaque so as to act as a scattering body for light propagated in the optical waveguide layer 3. As a result, the sensitivity is decreased to further deteriorate repeatability of the measurement.

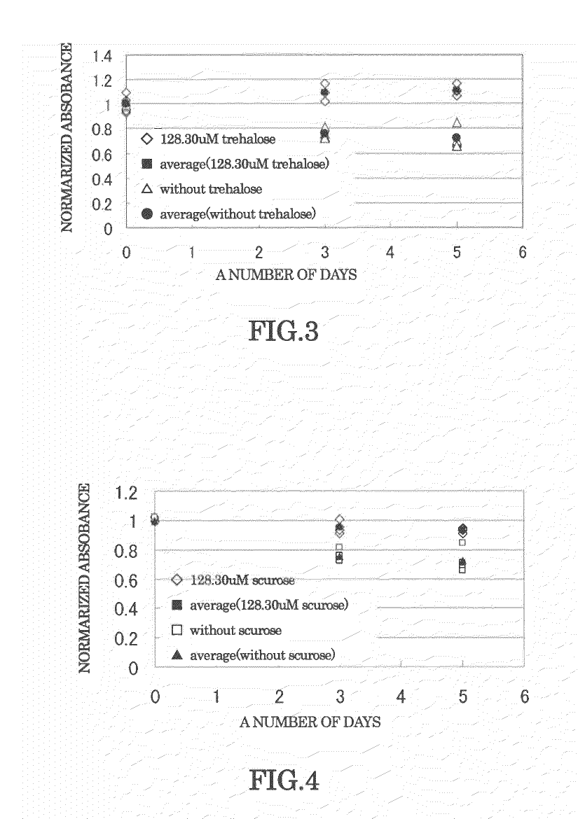

Next, measurement sensitivity of the glucose sensor chip 1 according to the embodiment is described as reference to FIG. 3 and FIG. 4.

FIG. 3 is a graph showing a change of absorbance (sensitivity) with accompanying progress of a storage period on the glucose sensor chip with adding trehalose into the sensing film in the embodiment and the glucose sensor chip 11 in the conventional case, respectively. In the measurement, added trehalose is constant, nearly 130 μM. After forming the sensing film, the glucose sensor chips are retained in a preservation state with a temperature of 37° C. for zero day, three days and five days, respectively. After 3 μl of 0.25 mg/dl glucose solution is fallen in drops into the sensing films of the glucose sensor chips according to the embodiment and the conventional case, respectively, measurements are performed as shown in FIG. 1. A laser is incident from a back surface side of the substrate 2 to refract on the grating 4 at the incident side, so that the laser is propagated in the sensing film 5. Further, the laser is refracted on the grating 4 at the emission side to be received with the light receiving element, so that strength (absorbance) of the laser is measured.

Consequently, both the normalized absorbance after three days and five days in the glucose sensor chip 1 of the embodiment are nearly 1.1, when the absorbance of zero day is standardized as 1.0. It is revealed that the normalized absorbance is not decreased with the preservation days.

On the other hand, the normalized absorbance after three days and five days in the glucose sensor chip 11 of the conventional case are decreased nearly 0.76 and further 0.72, respectively, when the absorbance of zero day is standardized as 1.0. As a result, it is revealed in the glucose sensor chip 11 of the conventional case that the normalized absorbance is decreased in the storage period. As a result, it is revealed that the glucose sensor chip 1 of the embodiment can be retained as a stability for the sensitivity as compared to the glucose sensor chip 11 of the conventional case.

FIG. 4 is a graph showing a change of absorbance (sensitivity) with accompanying progress of a storage period on the glucose sensor chip with adding sucrose into the sensing film in the embodiment and the glucose sensor chip 11 in the conventional case, respectively.

After fabricating the sensing film, the glucose sensor chips are retained in a preservation state with a temperature of 37° C. for zero day, three days and five days, respectively, as the same as shown in FIG. 3. After 3 μl of 0.25 mg/dl glucose solution of is fallen in drops into the sensing films of the glucose sensor chips according to the embodiment and the conventional case, respectively, measurements are performed as shown in FIG. 1. A laser is incident from a back surface side of the substrate 2 to refract on the grating 4 at the incident side, so that the laser is propagated in the sensing film 5. Further, the laser is refracted on the grating 4 at the emission side to be received with the light receiving element, so that strength (absorbance) of the laser is measured.

As a result, the glucose sensor chip 11 of the conventional case is the same as shown in FIG. 3. On the other hand, normalized absorbance after three days and five days in the glucose sensor chip 11 of the embodiment are decreased nearly 0.95 and further 0.9, respectively, when the absorbance of zero day is standardized as 1.0. As a result, normalized absorbance with adding sucrose decreased larger than that with adding trehalose, however, it is revealed that the normalized absorbance of the glucose with adding sucrose is not decreased than that without adding sucrose.

The glucose sensor chip 1 in the embodiment can stably retain measurement sensitivity from the results indicated in FIG. 3 and FIG. 4 as compared to the glucose sensor chip 11 in the conventional case.

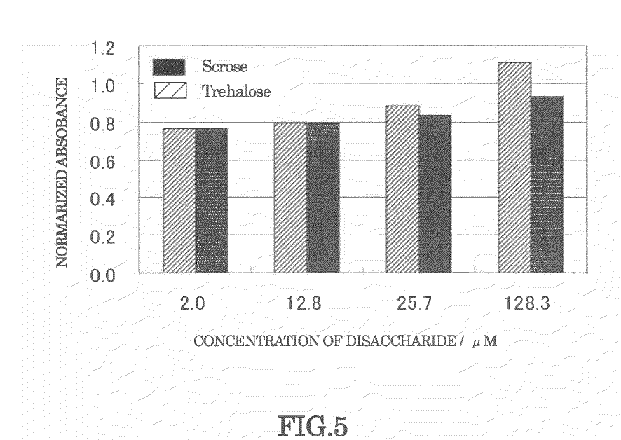

FIG. 5 is a graph showing a relationship on trehalose and sucrose as the low-molecule compound in the glucose sensor chip between the concentration of disaccharide and absorbance. In the experiment, samples with trehalose or sucrose which is added nearly 2 μM, 13 μM, 25 μM, and 130 μM, respectively, are prepared. The normalized absorbance measured after five days as the preservation days. In these measurements, the concentration and the volume of glucose is the same as the case which is measured on the normalized absorbance (sensitivity) with accompanying progress of the storage period mentioned above.

As a result, in the case of adding nearly 2 μM, 13 μM, 25 μM and 130 μM trehalose in the sensing film, respectively, the normalized absorbance are nearly 0.77, 0.79, 0.88 and 1.11. Further, in the case of adding nearly 2 μM, 13 μM, 25 μM and 130 μM sucrose, respectively, the normalized absorbance are nearly 0.76, 0.79, 0.83 and 0.93.

Therefore, it is revealed that the all glucose sensor chips 1, after five days, in which the concentration of the added low-molecular compound are set to be nearly 2 μM, 13 μM, 25 μM and 130 μM has higher normalized absorbance and can stably retain sensitivity as compared to the glucose sensor chip 11 in the conventional case. Accordingly, added concentration of the low-molecular compound as mentioned above is desired to be nearly 2 μM or more.

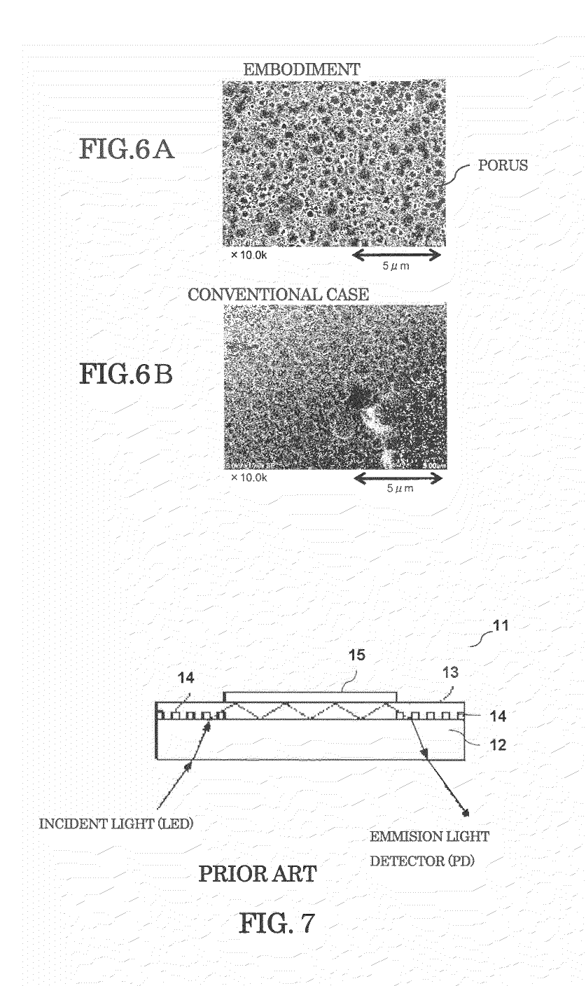

Next, a surface of each sensing film is explained as reference to FIG. 6. In FIGS. 6A and 6B, the glucose sensor chip 1 of the embodiment which can stably retain measurement sensitivity due to adding trehalose and the glucose sensor chip 11 of the conventional case which progresses five days after the film formation are respectively selected.

FIGS. 6A and 6B are SEM images showing the surface states of the sensing films of the glucose sensor chips according to the embodiment and conventional case, respectively. The added concentration of trehalose is set to be nearly 130 μM.

Porus below nearly 0.5 μm are formed all over the sensing film of the glucose sensor chip 1 in the embodiment as shown in FIG. 6A. However, porus below nearly 0.5 μm are not formed in the sensing film of the glucose sensor chip 11 in the conventional case as shown in FIG. 6B. In other words, it is revealed that the sensing film in the glucose sensor chip 1 in the embodiment as shown in FIG. 6A is formed as a porous film which is transparent.

A reason that the porus below nearly 0.5 μm is entirely formed on the sensing film in the embodiment as shown in FIG. 6A, for example, mentioned below. As the low-molecular compound such as trehalose is mixed into the sensing film, the low-molecule compounds penetrates into between molecules of cellulose derivative which acts as a binder of the membrane polymer so as to hydrogen-bond with cellulose derivative. Accordingly, aggregation due to hydrogen bonding between molecules of cellulose derivative is controlled. Further, the porus with nearly a circular type above nearly 0.5 μm are caused to be agglomerated by hydrogen bonding.

In such a manner, as the sensing film in the glucose sensor chip 1 in the embodiment becomes the porous film, permeability is higher than the glucose sensor chip 11 in the conventional case, it is revealed that the specimen solution can easily penetrate into the film.

As mentioned above, the glucose sensor chip having the sensing film as the porous film with measurement sensitivity can be provided according to the embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A glucose sensor chip, comprising:
an optical waveguide layer on a main surface of a substrate, the optical waveguide layer comprising a pair of gratings which are separated each other;
a sensing film on a surface of a portion of the optical waveguide layer between the pair of the gratings, the sensing film being constituted with a membrane polymer, a cross-linking polymer and a low-molecular compound, the sensing film comprising a first enzyme which oxidizes or reduces a color forming dye and a glucose, and a second enzyme which reacts with a product of the first enzyme and generates a material which produces the color forming dye.

2. The glucose sensor chip of claim 1, wherein
the low-molecular compound is disaccharide.

3. The glucose sensor chip of claim 2, wherein
the low-molecular compound of disaccharide is at least one selected from a group of trehalose, sucrose, and maltose.

4. The glucose sensor chip of claim 1, wherein
a density of the low-molecular compound in the sensing film is set to be a range from 2 μM to 200 μM.
